(19) United States
(12) Patent Application Publication
(10) Pub. No.: US 2016/0110828 A1
(43) Pub. Date: Apr. 21, 2016

(54) VISUALIZING NAMING DATA

(71) Applicant: Master-McNeil, Inc., Berkeley, CA (US)

(72) Inventors: Syndi Beth Master, Berkeley, CA (US); Robert Miller, Oakland, CA (US)

(21) Appl. No.: 14/516,505

(22) Filed: Oct. 16, 2014

(51) Int. Cl. G06Q 50/18; G06F 17/30

(52) U.S. Cl. CPC G06Q 50/184; G06F 17/30345; G06F 17/30528; G06F 17/30554; G06F 17/30867

(57) ABSTRACT

Visualizing potential naming conflict data is disclosed. Similarities of a plurality of potential naming conflicts are analyzed. The similarities are translated into visualization attributes. Each of the potential naming conflicts is graphically represented within an area. The potential naming conflicts are represented by markers displayed based at least in part on the visualization attributes.

### BACKGROUND OF THE INVENTION

Existing techniques to search for potential naming conflicts often provide search results in a minimally useful format. A search for potential naming conflicts may include, for example, a trademark, servicemark, brand name, domain name, business name, and/or other name-related search. Using traditional approaches, the results of a naming conflict search are often output as a list of potential naming conflicts. It may be cumbersome for a user to sift through the naming conflict search results presented in a list or other similar format. It would be useful if a naming conflict search platform could be developed that would output potential naming conflict search results in an information-rich manner.

### BRIEF DESCRIPTION OF THE DRAWINGS

Various embodiments of the invention are disclosed in the following detailed description and the accompanying drawings.

FIG. 1 is a block diagram illustrating embodiments of a system to visualize potential naming conflicts data.

FIG. 2 is a flowchart illustrating embodiments of a process to visualize potential naming conflict data.

FIG. 3 is a flowchart illustrating embodiments of a process of determining relevance values.

FIG. 4 is a block diagram illustrating embodiments of a process to generate visualization attributes.

FIG. 5 is a flowchart illustrating embodiments of a process of graphically representing potential naming conflicts.

FIG. 6A is a diagram illustrating embodiments of a graphical display.

FIG. 6B is a diagram illustrating embodiments of a graphical display.

FIG. 7 is a diagram illustrating embodiments of a graphical display.

FIG. 8 is a diagram illustrating embodiments of a graphical display.

FIG. 9 is a diagram illustrating embodiments of a three-dimensional graphical display.

FIG. 10 is a diagram illustrating embodiments of a three-dimensional graphical display.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Visualizing potential naming conflict data is disclosed. In various embodiments, a user enters name data including, for example, a name and/or other data associated with a name. The name may include, for example, a phrase, terms, and/or words that a user would like to register as a trademark and/or servicemark and/or use in commerce. One or more databases may be searched using the name data, and potential naming conflicts and associated naming conflict data are retrieved. Potential naming conflicts may include registered trademarks and/or servicemarks, common law trademarks and/or servicemarks, brand names, product names, service names, business names used by third parties, and/or any other information that may be an obstacle to use of a name. A relevance score is determined for each of the potential naming conflicts. The relevance score indicates a likelihood that the potential naming conflict would be an obstacle to registration and/or other use of the name. Each of the relevance scores is translated into one or more visualization attributes for a potential naming conflict. A visualization attribute may include, for example, position in a visualization, a distance from a given locus, color, size, texture, shading, line weight, animation, and/or any other attribute. A graphical display is generated representing each of the naming conflicts within an area. In the graphical display, naming conflicts are represented by markers, and each marker is displayed based at least in part on the visualization attributes. In some embodiments, a graphical display is generated including a locus representing the name and markers each representing a potential naming conflict. Each of the one or more markers is positioned relative to the locus at a location determined based on a relevance score-related distance value for the marker.

In various embodiments, the graphical display resembles a target, a bullseye, cluster diagram, bubble chart, word map, word cloud, and/or other two-dimensional display. In some cases, the graphical display resembles a sphere, cube, planetary system, an atom diagram, and/or other three-dimensional display. The above are several example visualizations, but the techniques disclosed herein are not limited to these visualizations. Any visualization approach may be used to represent importance of naming conflict values. Using the techniques disclosed herein a graphical display is provided that allows a user to easily visualize the landscape of potential naming conflicts that could be an obstacle to use of a name. The graphical display may, for example, allow a user without substantial trademark, branding, naming, and/or other expertise to evaluate potential naming conflicts.

In various embodiments, similarities of a plurality of potential naming conflicts are analyzed. The similarities are translated into visualization attributes. Each of the potential naming conflicts is graphically represented within an area. The potential naming conflicts are represented by markers displayed based at least in part on the visualization attributes.

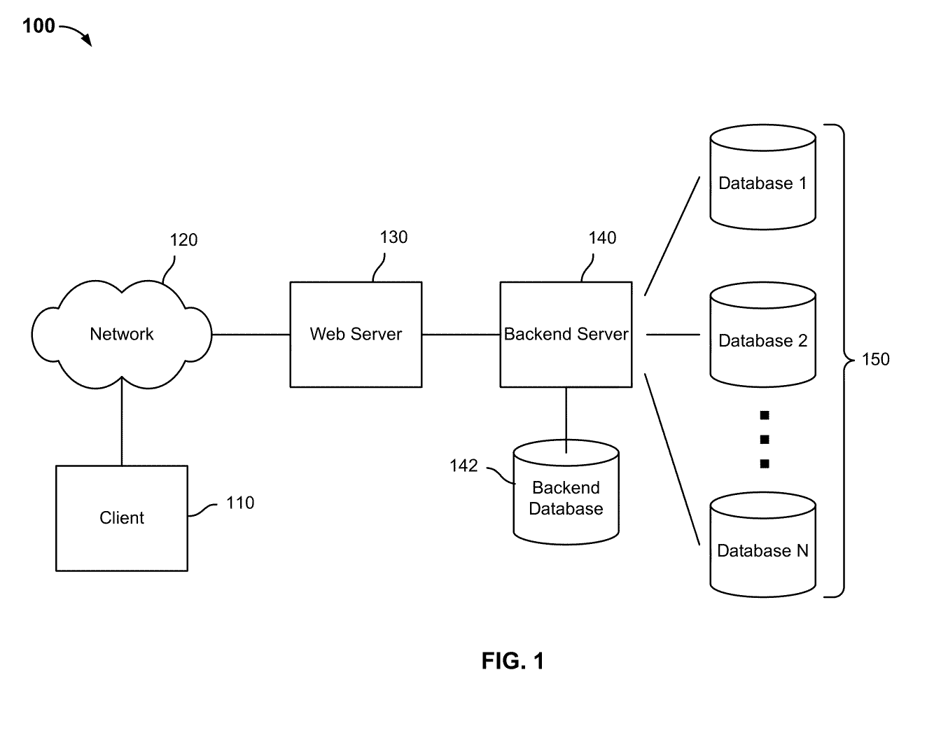

FIG. 1 is a block diagram illustrating embodiments of a system to visualize potential naming conflicts data. In the example shown, a data visualization system 100 includes a client device 110, a network 120, web server 130, backend server 140, and/or database(s) 150. The client device 110 may include a personal computer, laptop, mobile device, server, and/or other computing device. The client device 110 provides data to and/or receives data from the web server 130 via a network 120. The network 120 may include any combination of the Internet, high speed data networks, telecommunications networks, local area networks (LANs), wide area networks (WANs), Wi-Fi networks, and/or any other type of network. In one example, a user enters name data at the client 110, and the client 110 sends the name data to the web server 130 via the network 120. The web server 130 provides name data and/or other data received from the client 110 to the backend server 140.

In various embodiments, the backend server 140 searches the database(s) 150 using the name data and/or other data received from the client 110. The database(s) 150 may include, for example, any combination of trademark databases, business information databases, electronic yellow page databases, web search databases, private databases, public databases, search engine databases, and/or any other type of database including information related to naming data. The data stored in database(s) 150 may include data associated with the United States Patent and Trademark (USPTO) trademark database, the USPTO Trademark Electronic Search System (TESS) database, foreign trademark databases, and/or any other trademark databases. Business information databases may include industry-specific databases; business information services such as Dun & Bradstreet (D&B), Hoover's, and/or other services; and/or any other database including business-related information. Private and/or fee-based databases may include trademark, servicemark, and/or commercial information databases maintained by a third party, which in some cases may require a fee for access. In some embodiments, information from various databases 150 is stored (cached) in a database 142 associated with (local to) the backend server 140. In one example, the backend server 140 periodically retrieves data from the database(s) 150 and stores the data in a local database 142. Storing information in a local database 142 may increase the speed of data retrieval and/or graphical display generation.

In various embodiments, the backend server 140 queries database(s) 150 based on name data to retrieve potential naming conflict data. As discussed above, name data may include a name, goods and/or services description, a set of trademark classes, and/or any other information. The name data is used to query the database(s) 150 and/or backend database 142 for potential naming conflict information. Potential naming conflict information may include one or more potential naming conflicts, information associated with the naming conflicts, and/or other information. Potential naming conflicts may include, for example, trademarks (registered, unregistered, and/or common law), servicemarks (registered, unregistered, and/or common law), service names, product names, business names, domain names, names tied to goods or services, and/or any other commercially-related name. Potential naming conflicts may include any data that could potentially be an impediment to commercial usage of a name. Potential naming conflicts may also include any data that could potentially be an obstacle to registration of the name as a trademark, servicemark, brand name, domain name, business name, copyright, and/or as any other legally-enforceable instrument. In one example, a potential naming conflict includes a trademark and/or servicemark that is similar to a name to such a degree that use of the name in conjunction with goods, products, or services would result in a likelihood of confusion as to the source of the goods, products, or services. In various embodiments, potential naming conflict information includes factors associated with a potential naming conflict as discussed below.

In various embodiments, the backend server 140 processes the potential naming conflict data retrieved from the database(s) 150. The backend server 140 may include, for example, a potential naming conflict visualization engine (a visualizer) that processes the naming conflict data to generate a graphical representation. The potential naming conflict data is processed to generate a graphical representation including markers representing each of one or more naming conflicts. In one example, the potential naming conflict data is processed to generate a graphical representation including a marker representing the name and markers representing each of the multiple potential naming conflicts. In certain cases, the marker may include the name displayed in text. The process of generating the graphical display is discussed in detail below. In various embodiments, the backend server 140 generates the graphical display and provides the graphical display to the client device 110 via, for example, the web server 130 and network 120. The client device 110 outputs the graphical display.

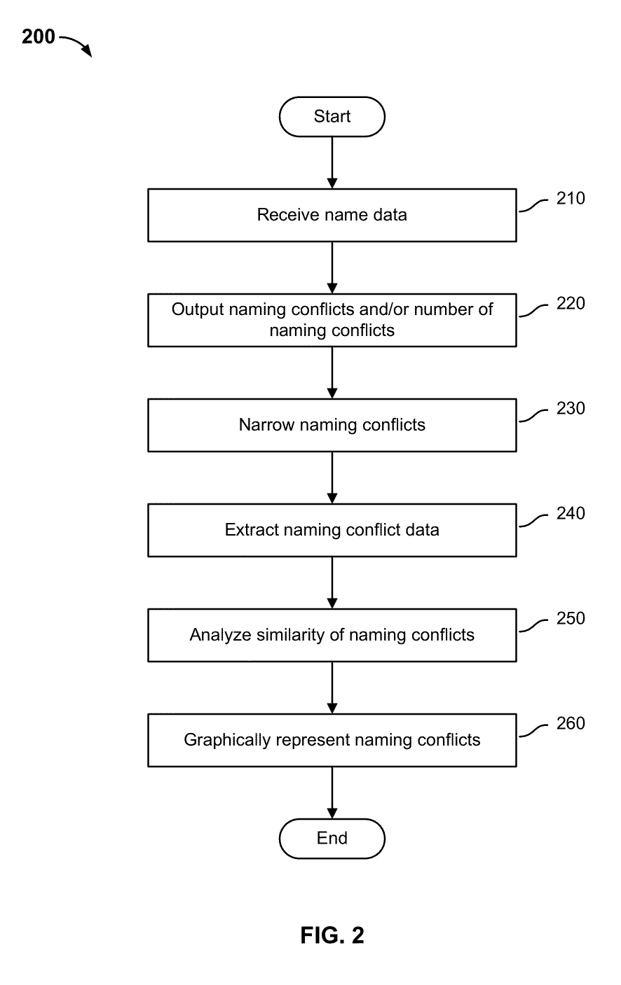

FIG. 2 is a flowchart illustrating embodiments of a process to visualize potential naming conflict data. In various embodiments, the process 200 is implemented by system 100 of FIG. 1. At 210, name data is received. As discussed above, the name data may include names, terms, phrases, and/or any other name related information. In some embodiments, the name data includes goods and/or services descriptions, trademark and/or servicemark classes, and/or other information suitable for entry into a trademark and/or servicemark database search field. By way of example, a user may enter name data including a name “Acme,” an international trademark class “009—Electrical and Scientific Apparatus,” and/or other information. The name data is passed from the client to the backend server.

In various embodiments, the backend server queries one or more databases based on the name data. The backend server retrieves potential naming conflict data from, for example, remote data sources, local data sources associated with the backend server, and/or any other data sources. The potential naming conflict data includes a plurality of potential naming conflicts and/or data associated with each of the naming conflicts. Each of the potential naming conflicts may include a hit.

At 220, potential naming conflicts and/or a number of potential naming conflicts is output. In various embodiments, the potential naming conflicts are retrieved by a backend server and passed to a client device for output. The potential naming conflicts may be output as a list of the naming conflicts, as a number of the naming conflicts, as a graphical representation of the naming conflicts, and/or in any other form. Continuing with the example above, a search of the databases based on the name data results in ten potential naming conflicts. The potential naming conflicts may include, for example, trademarks including the term “Acme” that are registered with an international trademark class “009—Electrical and Scientific Apparatus.” In certain cases, the potential naming conflicts also include business names, brand names, domain names, common law use of names, and/or other naming conflicts including the term “Acme.” The trademarks, business names, brand names, domain names, and/or other potential naming conflicts are output as a list including the naming conflicts, a number of naming conflicts, and/or other information.

At 230, the potential naming conflicts are narrowed. In various embodiments, a user narrows a list and/or number of potential naming conflicts. In one example, a user reviews the potential naming conflicts and/or the number of potential naming conflicts, and based on the review, the user provides updated name data. Name data may be updated by adding terms to and/or removing terms from a name. Name data may be updated by adding and/or updating a goods and services description, a trademark class, and/or other name data. Continuing with the above example, the user may update the name data for “Acme” to include a goods description “software,” and a trademark status of live. The updated name data is passed to the backend server and an updated search of the databases is performed. In this example, the updated search retrieves four (4) potential naming conflicts from the various databases.

In some embodiments, steps 220 and 230 of process 200 are not performed. Steps 220 and 230 are performed to narrow a potential naming conflict search to a meaningful number of hits. In the event an initial query based on the name data retrieves a low number of hits, it may indicate that the initial search was narrow enough to provide meaningful results, and the outputting and narrowing steps may not be performed. In one example, if the number of potential naming conflicts retrieved based on name data is less than a certain value, it is determined that the outputting and narrowing steps need not be performed.

At 240, potential naming conflict data is extracted. In various embodiments, potential naming conflict data is processed to extract factors associated with each of one or more potential naming conflicts. Potential naming conflict data may include potential naming conflicts (such as trademarks, servicemarks, business names, and/or other names) and data associated with each of the naming conflicts. The potential naming conflicts and data associated therewith are processed to extract factors associated with the one or more naming conflicts. Factors associated with a potential naming conflict may include, for example, a similarity of an existing mark (a potential naming conflict) and the name; a similarity of goods and services descriptions included in the name data and included in the naming conflict data; a similarity between a trademark class included in the name data and a trademark class associated with a naming conflict; a status associated with a naming conflict; a time and/or duration since a status change related to the naming conflict; data associated with an owner of a naming conflict including a trademark and/or servicemark; objections and/or challenges to an application to register; and/or any other information associated with a naming conflict.

In various embodiments, factors associated with a potential naming conflict are processed to determine a relevance score for the naming conflict. In certain cases, factors associated with a potential naming conflict are quantified, scaled, weighted, and/or otherwise processed. The factors may be processed for inclusion in a feature vector for the potential naming conflict. The feature vector is used to determine a relevance score for the potential naming conflict. The process of generating a feature vector is discussed in detail below.

At 250, similarities between the name data and the potential naming conflicts are analyzed. In various embodiments, a relevance score and/or value is generated for each of one or more potential naming conflicts. In certain cases, a relevance score is determined by applying weights to each of one or more factors associated with a potential naming conflict. In some cases, a feature vector is generated including factors associated with a potential naming conflict. Linear and/or non-linear transformations are applied to the feature vector to determine a relevance score. In one example linear transformation, the feature vector is multiplied component-wise by a vector including weights corresponding to each factor and/or element in the feature vector. And the sum of these products is used to generate a relevance score for the potential naming conflict. In another example, non-linear transformation(s), such as logistic regression, kernel methods, and/or manifold learning are applied to the feature vector to determine a relevance score. In a further example, a combination of linear and non-linear transformations is applied to the feature vector to generate a relevance score.

At 260, the potential naming conflicts are graphically represented. In some embodiments, a graphical display is generated including markers representing each of one or more naming conflicts. Each of a plurality of markers is displayed based on visualization attribute(s) associated with the marker. The visualization attribute(s) are determined based on the relevance score calculated for the marker. The visualization attributes may include, for example and without limitation, distance from a given locus, coordinate location in a display, size, color, texture, shading, line weight, animation, and/or any other display-related attributes of a marker. A relevance score for a marker may be scaled, transformed, weighted, and/or otherwise translated to one or more visualization attributes.

By way of example, a size of a marker may be determined based on the relevance score for the marker. A first marker associated with a larger relevance score may, for example, appear larger in a display than a second marker associated with a smaller relevance score. In another example, a color of a marker is determined based on a relevance score for the marker. In this case, a first marker associated with a higher relevance score is displayed including a more intense color (e.g., red) and a second marker associated with a lower relevance score is displayed including a less intense color (e.g., blue). A relevance score of a marker may be used to determine any attribute associated with the visualization of the marker. A displayed marker may embody any of a wide variety of visualization attributes to represent a relevance score associated with the marker.

In various embodiments, a graphical display is generated including a locus and markers. The locus represents a name provided by a user, and each of the one more markers represents a potential naming conflict. Each of the markers is positioned at a determined coordinate. In some cases, the coordinate is determined based on a relevance score-based distance from the locus. The distance between the locus and a marker is determined based on the relevance score calculated for that marker. For example, a relevance score for a marker may be scaled, transformed, weighted, and/or otherwise translated to a distance, and the relevance score-based distance is used to determine a coordinate location for the marker in the graphical display. As a result, the coordinate of a marker and/or other visualization attributes of the marker are determined based on a relevance score and/or other information associated with a naming conflict that the marker represents.

In various embodiments, the locus and markers are displayed in a two-dimensional display resembling a target, bullseye, dart board, a cluster diagram, and/or other type of two-dimensional graphical display. In various embodiments, the locus and markers are displayed in a three-dimensional volume. In one example, a three-dimensional volume resembles a diagram of an atom, a planetary system diagram, a sphere, a cube, and/or another diagram in which objects appear to be orbiting a locus. Various types of graphical representations are described in detail below.

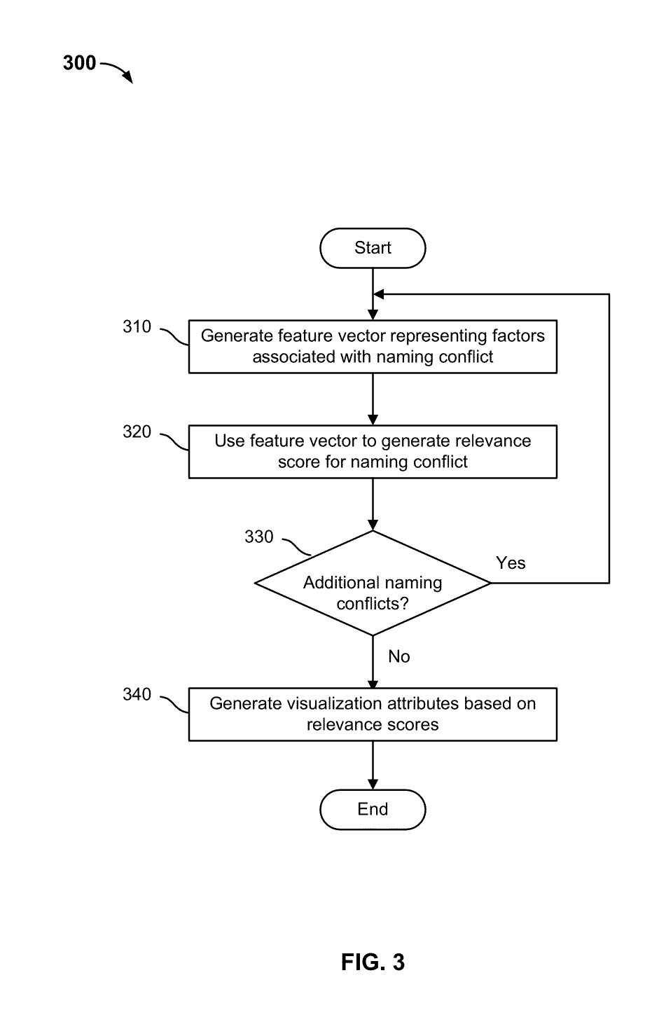

FIG. 3 is a flowchart illustrating embodiments of a process of determining relevance values. In some embodiments, the process 300 of FIG. 3 is used to implement step 250 of FIG. 2. At 310, a feature vector representing factors associated with a potential naming conflict is generated. In various embodiments, a feature vector is generated for each of one or more potential naming conflicts. A feature vector includes one or more elements each corresponding to a factor associated with a potential naming conflict. Each of the elements in a feature vector quantifies and/or otherwise represents a factor associated with a potential naming conflict.

Factors associated with a potential naming conflict may include a similarity of an existing trademark or servicemark (a potential naming conflict) and a name. In certain cases, a similarity between an existing mark—for example, a registered trademark—and a name is determined using natural language processing and/or other approaches. In some cases, a phonetic similarity between an existing mark and a name is determined using natural language processing and/or other approaches. In some cases, terms included in a name are compared to literal elements of an existing trademark to determine a level of similarity. The similarity may be quantified. In one example, a similarity value is generated on a scale of, for example, 0 to 100 and/or any other scale. The similarity value is included as an element of a feature vector for the naming conflict.

Factors associated with a potential naming conflict may include a similarity and/or overlap of a goods and services description included in the name data and a goods and services description of a registered mark. The similarity of goods and services description values may be determined using natural language processing and/or other approaches. In certain cases, a similarity value is generated that quantifies a similarity between a goods and services description in the naming data and a goods and services description in the registered mark.

Factors associated with a potential naming conflict may include an overlap and/or similarity between a trademark class included in the name data and a trademark class associated with a potential naming conflict. In one example, name data includes one or more trademark classes selected by a user. These trademark classes are compared to trademark classes associated with a registered mark that is determined to be a potential naming conflict. A similarity value representing the overlap and/or similarity between the trademark classes in the name data and the registered mark is generated. In the event one or more of the trademark classes included in the name data are the same as the trademark classes associated with a registered mark, a higher similarity value is generated. In the event no classes overlap between the name data and the registered mark, a lower similarity value is generated.

Factors associated with a potential naming conflict may include data indicating a status of a mark (a potential naming conflict), such as live, active, abandoned, cancelled, and/or any other status. In certain cases, a status of a potential naming conflict is quantified to reflect an extent to which the status could affect usage of the name. In one example, a status of live corresponds to a value 1.0 indicating a higher likelihood of conflict, a status of abandoned may correspond to a value of 0.2 indicating a lower likelihood of conflict, and so on.

Factors associated with a potential naming conflict may include a date on which and/or duration since a trademark application was filed. The duration may be represented as a number of days since registration and/or another value representing a duration of time since a trademark application for the potential naming conflict was filed. In certain cases, trademarks and/or servicemarks gain strength over time as they are used in commerce. And a duration of time that a mark has been registered and/or used in commerce may indicate a mark's strength.

Factors associated with a potential naming conflict may include a time and/or duration that a potential naming conflict has been abandoned, dead, and/or otherwise inactive. In certain cases, the duration is represented as a value indicating a number of days since a change in status. The longer a mark has been abandoned, the less likely the mark would be an obstacle to use of a name in commerce. In certain cases, the more recent the time that a name has gone abandoned, the greater the chance it is still used in commerce and/or common law rights may be enforceable.

Factors associated with a potential naming conflict may include attributes associated with an owner of the trademark. Attributes of an owner of a potential naming conflict may include, for example, market capitalization of the owner, corporate status (for example, publicly-traded, privately-held, etc.) of the owner, litigiousness of the owner, prior history of trademark enforcement by the owner, prior history of trademark registration challenges and/or objections by the owner, and/or other information known about the owner of the potential naming conflict. Attributes associated with an owner of a potential naming conflict may reflect a likelihood that the owner would exercise their rights (if any) to block usage and/or registration of the name. By way of example, a trademark owner that is a publicly-traded company with a large market capitalization may have more resources to enforce their trademark rights than a small, privately-held company with a smaller market capitalization. Attributes associated with an owner of a trademark are quantified for inclusion in a feature vector. For example, a score is generated representing the attributes associated with the owner.

The factors discussed herein include several example factors that may be represented in a feature vector for a potential naming conflict. Many other types of factors may, however, be used. Other factors may include and/or be based on, for example, any information associated with a potential naming conflict, any information associated with a relationship between a name and a potential naming conflict, and/or any other information.

In various embodiments, a feature vector associated with a potential naming conflict includes one or more elements each representing a factor associated with the potential naming conflict. The factors associated with a naming conflict are processed to generate feature vector elements representing and/or quantifying the factors. Upon generation, a feature vector includes one or more elements each of which quantify a likelihood that the potential naming conflict would be an obstacle to registration of a name and/or use of the name in commerce.

At 320, a feature vector is used to generate a relevance score for a potential naming conflict. In various embodiments, linear transformations, non-linear transformations, and/or other operations are performed on a feature vector associated with a potential naming conflict to generate a relevance score. In certain cases, a machine learning-associated approach is used to generate and/or apply linear and/or non-linear transformation to the feature vector to generate a relevance score.

In some embodiments, a linear transformation is applied to a feature vector and/or elements of a feature vector to determine a relevance score for the feature vector and/or a potential naming conflict associated with the feature vector. In an example linear transformation, the feature vector is multiplied by a vector including weights corresponding to each factor and/or element in the feature vector. And the scalar and/or vector product of the feature vector and the weights vector is used to generate a relevance score for the potential naming conflict. As part of an example vector multiplication, each factor and/or element of a feature vector is multiplied by a weight, and a sum of the products of the factors and weights includes a relevance score for the feature vector. In some cases, an aggregation of the sum of the products of the factors and weights is scaled to generate a relevance score. The relevance score for the feature vector may include a relevance score for the potential naming conflict associated with the feature vector.

In various embodiments, the weights are determined using a machine learning approach including, for example, supervised learning and/or other approaches. In an example training operation, training data sets including name data (names), potential naming conflicts, feature vectors associated with the potential naming conflicts, relevance scores, and/or other data are provided to a potential naming conflict visualization engine. A potential naming conflict visualization engine (visualizer), which may be associated with backend server 140 of FIG. 1, uses the training data to determine a weight value for each factor. These weights are then used to determine relevance scores for each of the multiple naming conflicts.

In some embodiments, the weights applied to each factor and/or element in a feature vector are determined based on user input. In one example, a user is provided an interface to adjust (increase or decrease) the weights applied to each factor included in a feature vector. In one example, a user may adjust a weight that is applied to the factor representing the similarity between the terms in the name and the literal elements of a registered trademark—a term similarity factor. A user may increase and/or decrease this weight to increase and/or decrease the importance of the term similarity factor in calculating a relevance score for a potential naming conflict. By adjusting the weights applied to each factor, a user is able to custom tailor the system to match the requirements of a particular trademark, branding, and/or other name search.

In various embodiments, other parameters that are not directly applied to the feature vector may be adjusted. For example, a user may adjust a risk tolerance. A risk tolerance may indicate a user's overall aversion to risk associated with potential naming conflicts. The risk tolerance may be used to scale, weight, and/or otherwise process relevance score values. For example, if a user decreases a risk tolerance indicating the user has a lower tolerance to risk, relevance scores associated with certain naming conflicts may be increased.

In various embodiments, non-linear transformation(s), such as logistic regression, kernel methods, and/or manifold learning, are applied to the feature vector to determine a relevance score. In some embodiments, a combination of the linear transformation(s) and non-linear transformation(s) are applied to a feature vector to generate a relevance score.

At 330, it is determined whether any additional potential naming conflicts exist. In some embodiments, feature vectors are generated for each of one or more potential naming conflicts. As discussed above, one or more sets of potential naming conflict data are retrieved from various databases, and feature vectors are generated for each set of potential naming conflict data. In the event feature vectors have not been generated for a potential naming conflict, the process proceeds to step 310. In the event feature vectors have been generated for all potential naming conflicts, the process proceeds to step 340.

According to some embodiments, relevance scores are generated for each of one or more potential naming conflicts. By way of example, name data including a name “Atlas” and a goods and services description of “navigation software” is used to query one or more databases and four (4) potential naming conflicts are retrieved. The potential naming conflicts include “Atlas Air,” “Atlas Gaming,” “Discovery Atlas HD,” and “Atlas, Inc.,” which is associated with a goods and services description of “geographical survey software.” Feature vectors are generated for each of the potential naming conflicts, and the feature vectors are each processed to generate relevance scores for each of the potential naming conflicts. For example, “Atlas Air” is associated with a relevance score of 0.25, “Atlas Gaming” is associated with a relevance score of 0.5, “Discovery Atlas HD” is associated with a relevance score of 0.25, and “Atlas, Inc.” is associated with a relevance score of 0.75. As discussed below, the relevance scores may be used to determine visualization attributes, such as distance values, marker sizes, marker colors, marker shadings, and/or any other display-related attribute.

At 340, visualization attributes are generated based on the relevance scores. In various embodiments, relevance scores each associated with a potential naming conflict are scaled, transformed, weighted and/or otherwise translated to generate visualization attributes for each of the naming conflicts. In one example, visualization attributes include distance values. A distance value may include a number of pixels; a distance in a unit of measure, such as inches, centimeters, etc., within a graphical display; a vector distance; scalar distance; and/or any other distance value. The distance value is used to graphically represent a level of similarity and/or relevance between a name and the potential naming conflict. In some embodiments, a relevance score is linearly and/or non-linearly scaled or transformed to generate a distance value. In various embodiments, a distance value is inversely proportional to a relevance score. For example, a higher relevance score, indicating a greater degree of similarity between a name and a potential naming conflict, is translated to a shorter distance from a locus representing the name. Depending on the graphical display approach used, a shorter distance between a potential naming conflict and name may indicate greater potential for conflict between the name and naming conflict.

In some embodiments, relevance scores for each of multiple potential naming conflicts may be processed to generate visualization attributes for each of the potential naming attributes. In one example, the visualization attributes include distance values for each of the potential naming conflicts. In some cases, a range of relevance score values across multiple potential naming conflicts is determined. The largest relevance score is assigned a smallest distance value and the smallest relevance score is assigned a largest distance value. The other relevance scores may be translated (linearly and/or non-linearly) to distance values within a range bounded by the largest distance value and smallest distance value.

Continuing with the above example, the “Atlas Air” relevance score 0.25 is scaled to a distance of three (3) units, the “Atlas Gaming” relevance score 0.5 is scaled to a distance of two (2) units, the “Discovery Atlas HD” relevance score of 0.25 is scaled to a distance of three (3) units, and the “Atlas, Inc.” relevance score 0.75 is scaled to a distance of one (1) unit. A unit may correspond to a number of pixels (pixel distance), a coordinate distance in a graphical display, and/or another value. The units may be scaled based on the size of the display including the locus and markers. The determined distance values are used to generate a graphical display including a representation of the name (“Atlas”) and marker representing the potential naming conflicts. In one example graphical display, a graphical representation of the name “Atlas” is displayed at the center (bullseye) of an oval-shaped display resembling a target. A marker representing the potential naming conflict “Atlas, Inc.” is displayed a distance of one (1) unit from the center of the oval-shaped display. Similarly, a marker representing the potential naming conflict “Atlas Gaming” is displayed at a distance of two (2) units from the locus and markers representing the potential naming conflicts “Atlas Air” and “Discover Atlas HD” are displayed a distance of three (3) units from the locus. In certain cases, markers representing the potential naming conflicts “Atlas Air” and “Discover Atlas HD” are displayed at two separate locations that are each a distance of three (3) units from the locus. The markers may be displayed at two separate locations so the markers do not overlap and/or clutter the display.

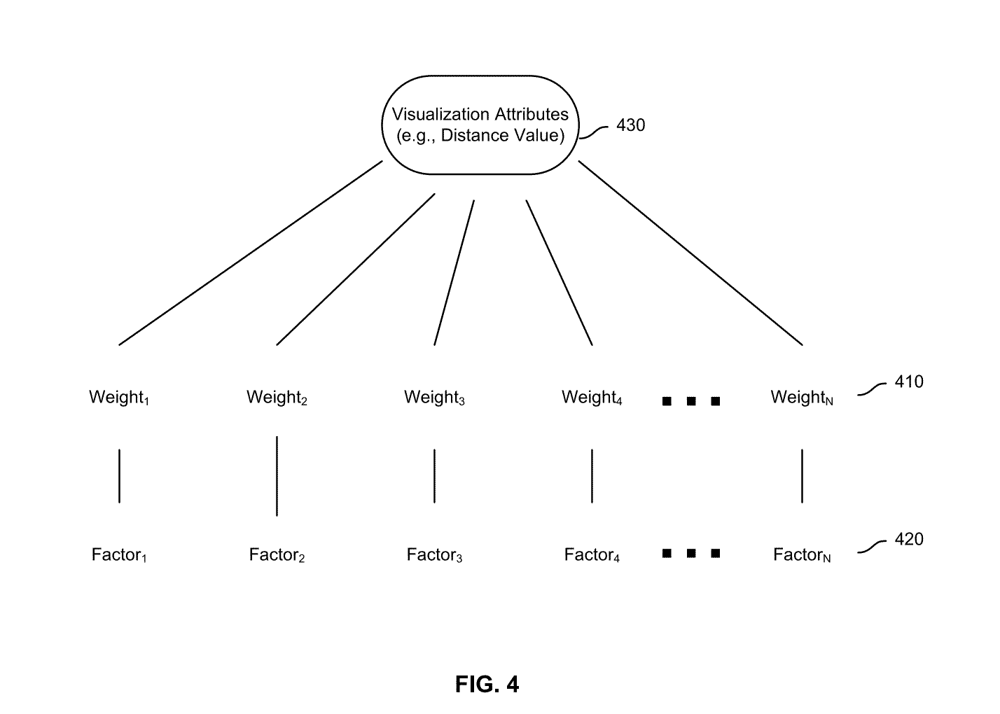

FIG. 4 is a block diagram illustrating embodiments of a process to generate visualization attributes. In various embodiments, weights 410 are applied to factors 420 associated with a potential naming conflict. In certain cases, a feature vector is generated for a potential naming conflict, and the feature vector includes factors 420 associated with the potential naming conflict. As shown in the example, a feature vector includes a first factor (Factor₁), a second factor (Factor₂), and so on up to an Nth factor (Factor_{N}). In an example linear transformation, the feature vector is multiplied by a vector of weights 410 including a first weight (Weight₁), a second weight (Weight₂), and so on up to an Nth weight (Weight_{N}). As part of an example scalar vector multiplication operation, each factor 420 of the feature vector is multiplied by a corresponding weight 410 included in a weight vector. For example, the first factor (Factor₁) is multiplied by the first weight (Weight₁), the second factor (Factor₂) is multiplied by the second weight (Weight₂), and so up to the Nth factor (Factor_{N}) which is multiplied by the Nth weight (Weight_{N}). A relevance score for the potential naming conflict is generated based on an aggregation of the products of factors 420 and weights 410. In some cases, a relevance score is equivalent to the sum of the products of the factors 420 and corresponding weights 410.

In various embodiments, the relevance score is translated into one or more visualization attributes 430. In some cases, a relevance score is scaled, transformed, mapped, and/or otherwise translated to one or more visualization attributes 430. For example, relevance scores for each of multiple potential naming conflicts are calculated, and the relevance scores for each of the potential naming conflicts are scaled relative to one another to generate distance values for each of the potential naming conflicts. The distance values are used to generate marker placements in a graphical representation of the name and potential naming conflicts. In another example, relevance scores for each of the multiple potential naming conflicts are calculated, and the relevance scores for each of the potential naming conflicts are scaled relative to one another to generate sizes for markers representing each of the potential naming conflicts. The sizes determine a size of a marker, such as a bubble, pin, block, etc., in a graphical representation of the naming conflicts. In this case, larger markers are associated with higher relevance scores and smaller markers are associated with lower relevance scores. In a further example, relevance scores for each of the multiple potential naming conflicts are calculated, and the relevance scores for each of the potential naming conflicts are scaled relative to one another to generate colors for markers representing each of the potential naming conflicts. In this case, markers representing naming conflicts of higher relevance are displayed in brighter colors and markers representing naming conflicts of lower relevance are displayed in lighter colors.

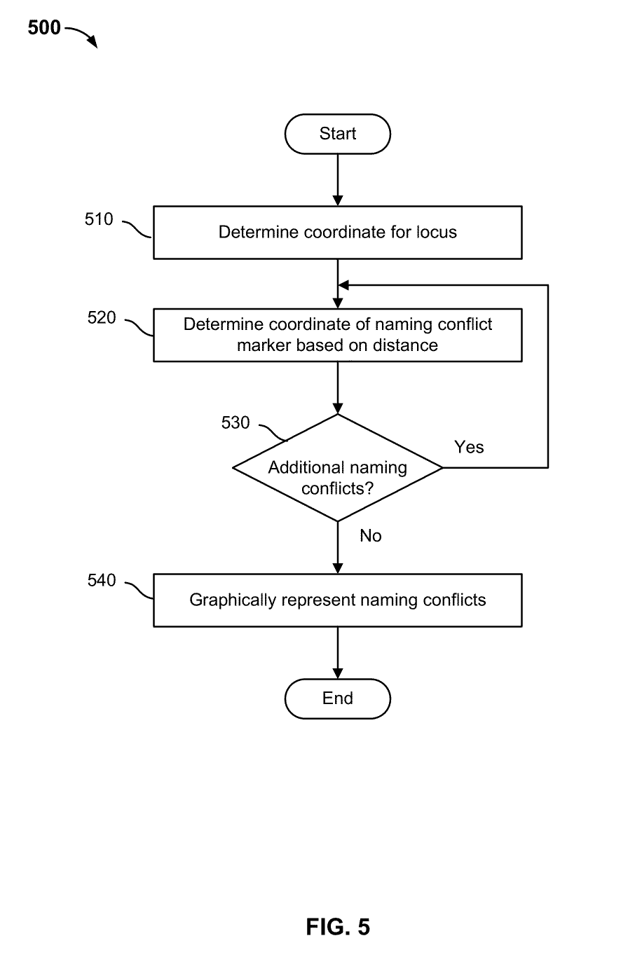

FIG. 5 is a flowchart illustrating embodiments of a process of graphically representing potential naming conflicts. In some embodiments the process 500 of FIG. 5 is used to implement step 260 of FIG. 2. The process 500 is used to generate certain example types of graphical displays; however, other types of graphical displays are contemplated within the scope of the present disclosure. In various embodiments, the process 500 is used to generate a graphical display in which markers representing naming conflicts are displayed as coordinates relative to a given locus.

At 510, a coordinate is determined for a locus. In various embodiments, a coordinate defining a locus of a name is determined. The locus of a name includes a location at which a name and/or an image representing the name is to be displayed in a graphical display. The coordinate of the locus may be defined in an x-y coordinate system, a polar coordinate system, and/or any other coordinate system. In certain cases, a coordinate of the locus is located at a center of a coordinate system. In one example, a coordinate of a locus in an x-y coordinate system includes a (0,0) coordinate.

At 520, a coordinate is determined for a potential naming conflict marker. In some embodiments, a coordinate of a marker representing a potential naming conflict is determined based on a distance value and/or relevance score associated with the potential naming conflict. In various embodiments, a coordinate is generated for each of one or more potential naming conflicts. A coordinate at which a marker associated with a potential naming conflict is placed in a graphical display is determined based on the distance associated with the potential naming conflict. In some cases, a distance between the locus and the marker associated with the potential naming conflict is equivalent to and/or proportional to the distance calculated using the techniques disclosed herein.

In some embodiments, a location of a marker representing a potential naming conflict is defined in Cartesian coordinates (x-y coordinates), polar coordinates, and/or another coordinate system. In one example using Cartesian coordinates, a distance value for a potential naming conflict is used to determine an x-y coordinate (x-y pixel location) for the marker. The x-y coordinates for each marker are determined such that the distance between the x-y coordinate of the marker and the x-y coordinate of the locus is equivalent to the calculated distance. In the event multiple potential naming conflicts are associated with a same distance value, each of the multiple potential naming conflicts is positioned at separate x-y coordinates equidistant from the x-y coordinate of the locus. The separate x-y coordinates may be determined such that the markers associated with the potential naming conflicts do not overlap and/or are not clustered together in the graphical display. By way of example, a distance value of five (5) is calculated for a potential naming conflict using the techniques discussed above. A locus representing a name is located at a coordinate (0,0) and a marker representing the potential naming conflict is located at a coordinate (3,4), which is located a distance of five (5) units from the locus at (0,0).

In another example using polar coordinates, a distance value associated with a potential naming conflict is used to determine a radius between a marker associated with the potential naming conflict and the locus associated with the name. An angle coordinate (φ) for each of the markers may be determined randomly, based on a determined importance of a potential naming conflict associated with the marker, determined such that markers are evenly distributed in the graphical display, and/or determined so that no two markers overlap. In one example, a distance of 2.5 is calculated for a potential naming conflict. In this case, the marker representing the potential naming conflict is located at coordinate)(2.5,45° and/or another coordinate a distance of 2.5 units from a locus at (0,0).

At 530, it is determined whether any additional potential naming conflicts are to be displayed. In the event additional potential naming conflicts are to be displayed, the process proceeds to step 520 and coordinates are determined for the additional potential naming conflicts. In the event no additional potential naming conflicts are to be displayed, the process proceeds to step 540.

At 540, the potential naming conflicts are graphically represented. In various embodiments, a graphical representation includes a locus representing the name and one or more markers each representing a potential naming conflict. Each of the markers is positioned at a coordinate determined based on a relevance-based distance from the locus as discussed above.

In various embodiments, the locus and markers are displayed in a two-dimensional display resembling a target, a dart board, a cluster diagram and/or other type of display. The locus representing a name may be positioned at the center of the two-dimensional display at a coordinate (0,0), and each of the markers representing potential naming conflicts are positioned around the locus at coordinates determined based on a relevance score-based distance value associated with a naming conflict.

In some embodiments, a graphical display includes a three-dimensional volume. A three-dimensional volume may resemble, for example, a planetary system diagram, a diagram of an atom, a sphere, a cube, and/or other diagram in which markers representing potential naming conflicts appear to be orbiting a locus. The graphical representations described herein are provided as examples. Many other types of graphical displays are, however, within the scope of the present disclosure.

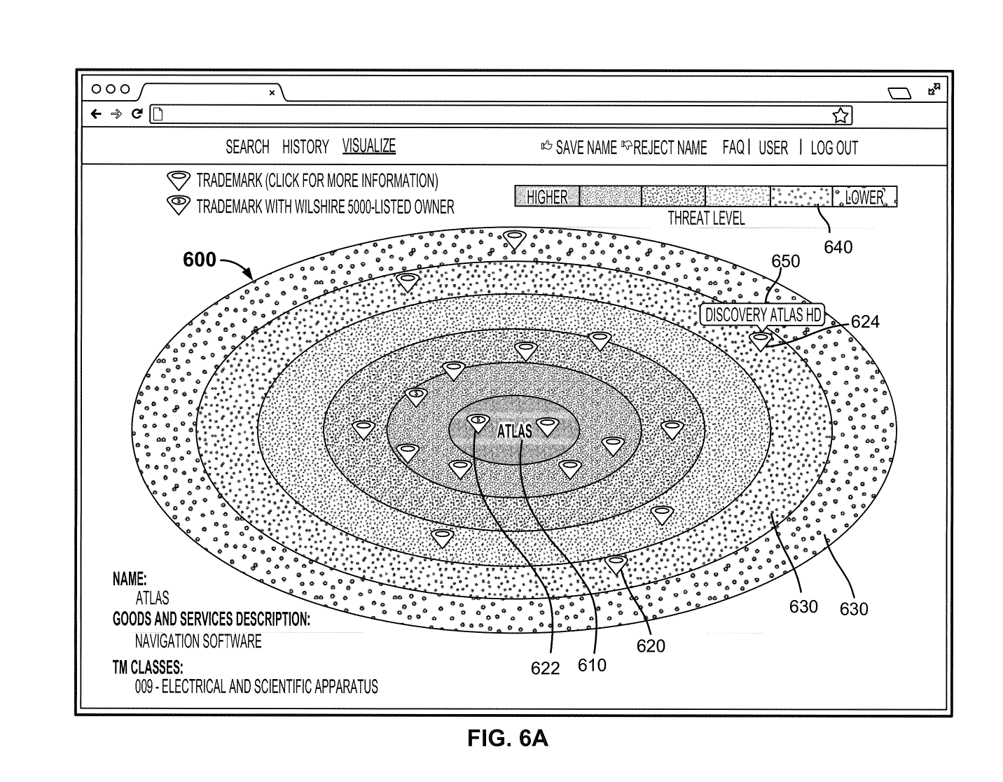

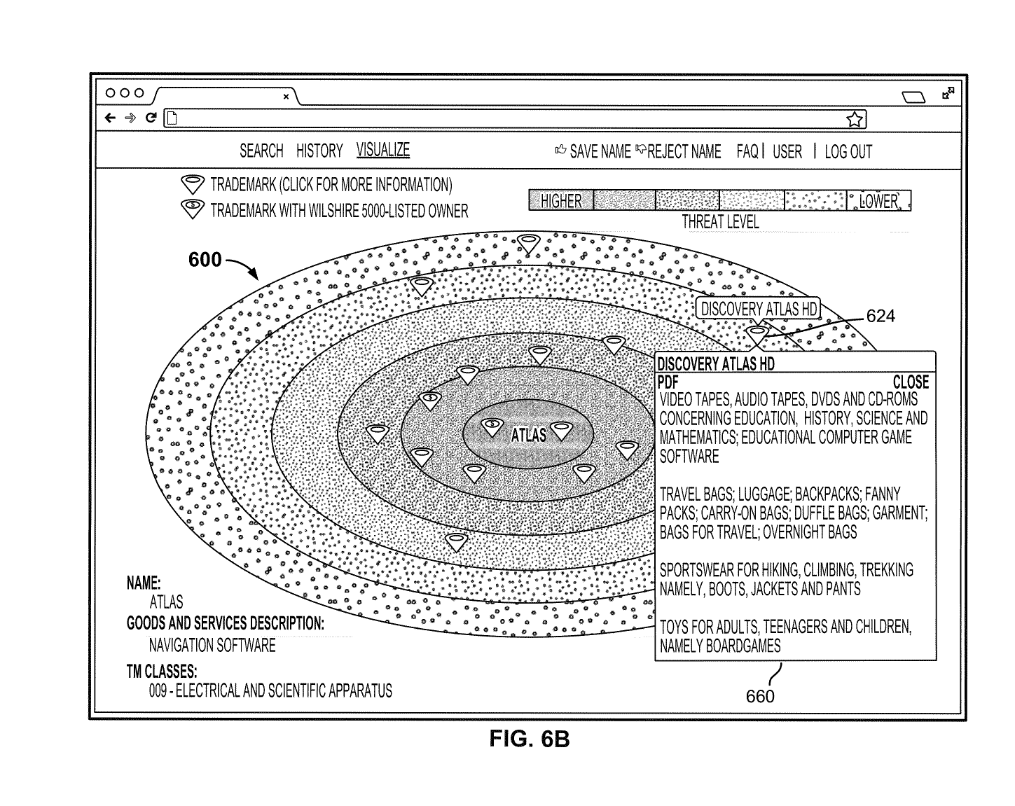

FIG. 6A is a diagram illustrating embodiments of a graphical display. In the example shown, an oval-shaped graphical display 600 includes a locus 610 representing a name “ATLAS” graphically displayed at a center of the display 600. Markers 620 representing potential naming conflicts are displayed in the oval-shaped display 600 according to visualization attributes associated with each marker. Visualization attributes may include, for example, distance from the locus 610, color of a marker, size of a marker, shading of a marker, apparent texture of a marker, line weight of a marker, animation characteristics of a marker, and/or other visualization attributes. Markers 620 representing potential naming conflicts are displayed in the oval-shaped display 600 at various locations. The coordinate location (a visualization attribute) of a marker 620 representing a potential naming conflict is determined based on a relevance score-based distance for the potential naming conflict. The oval-shaped display 600 resembles a target, bullseye, dartboard, and/or other type of display. Like a target, bullseye, and/or dartboard, in this visualization, the closer a marker 620 is to the center of the display 600, the higher the relevance score associated with the marker 620. For example, the markers 620 located closest to the center locus of the display 600 represent potential naming conflicts that are most likely to be an obstacle and/or threat to usage of the name in commerce. Similarly, markers 620 further away from the center of the display 600 represent potential naming conflicts that are less likely to be a threat to usage in commerce and/or registration of the name.

In some embodiments, coordinates (such as Cartesian coordinates, polar coordinates, and/or other coordinates) of the markers 620 are determined to maximize the information conveyed by the display 600. In certain cases, markers 620 are positioned radially about the oval-shaped display 600 so that the multiple markers are not clumped together and/or displayed overlapping one another. In one example, multiple markers 620 are associated with the same distance values. To avoid overlap, one marker is displayed in a position that appears closer to the viewer (below the center of the display 600) and another marker is positioned in a position that appears further from the user (above the center of the display 600). In this case, both markers are positioned equidistant from the locus but at different positions. In some cases, a radial location of a marker 620 is determined randomly, based on an importance of a potential naming conflict associated with a marker, and/or based on other factors. In one example, markers associated with potential naming conflicts deemed to be more important are displayed in a position that appears closer to the user (below the locus 610), while markers deemed to be less important are displayed in a position that appears further from the user.

In the example shown, oval ring-shaped areas 630 are displayed. The oval ring-shaped areas 630 provide a visual indication (scale) of the relevance and/or threat of potential naming conflict markers 620 displayed within the various rings. Each ring 630 may, for example, be associated with a degree or level of relevance and/or threat. For example, a ring 630 (or oval) at the center of the display 600 indicates a highest relevance and/or threat level, and the markers 620 included in the center ring 630 (or oval) represent the most relevant potential naming conflicts. The most relevant potential naming conflicts may pose a highest threat to registration and/or use of the name in commerce. A level of relevance and/or threat associated with each sequential ring decreases as the distance from the center increases. The markers 620 in the ring furthest from the center of the display 600 represent the least relevant potential naming conflicts. In various embodiments, each of the rings includes a different color, pattern, and/or other display attribute. In one example, the center ring may include a red or other color indicating a high threat level and the outermost ring may be a cool color, such as white, that indicates low threat level. In some embodiments, a legend 640 is displayed including the ring colors/patterns and associated threat levels.

In some embodiments, potential naming conflicts are categorized into groups based on associated distance values, and each group of potential naming conflicts is displayed in a ring 630. For example, distance values are calculated for each name conflict and the distance values are grouped into ranges. A first group may include potential naming conflicts associated with distance values in the range of 0 to 5, a second group may include potential naming conflicts associated with distance values in the range of 5.01 to 10, and so on. Markers 620 for the first group of potential naming conflicts are displayed in the innermost ring and/or oval, markers for the second group are displayed in the ring directly outer to the innermost ring, and so on. In certain cases, markers 620 displayed in a certain ring and/or associated with a range of distances are spread evenly throughout the ring. In some cases, markers 620 in a ring are spread randomly throughout the ring.

In various embodiments, markers include indicators (symbols) that convey information related to the potential naming conflict associated with the marker. In the example shown, certain markers 622 include a dollar sign indicating that the owner of the potential naming conflict is a publicly-traded company, such as a Wilshire 5000-listed company. In another example (not shown), markers include symbols indicating a country and/or jurisdiction associated with a potential naming conflict. Other markers may include an indicator denoting a status, such as live, dead, abandoned, and/or other characteristics of the trademark associated with the marker.

In some embodiments, potential naming conflict text 650 is displayed in conjunction with a marker 624. In the example shown, a user interacting with the display 600 hovers a cursor over a marker, and in response to the cursor hover indication, potential naming conflict text 650 “Discovery Atlas HD” and/or other potential naming conflict-related information is displayed with the marker. The potential naming conflict text 650 may include trademark literal elements, a business name, and/or any other potential naming conflict data. The above examples are for illustration purposes and are in no way exhaustive. A marker may include indicators representing any type of information associated with the potential naming conflict and/or name.

In various embodiments, an interface is provided for a user to save, reject, share, and/or perform other operations related to naming conflict search results included in a graphical display. In some embodiments, an interface is provided to save the history of a naming conflict search and/or the graphical representation of the search. The user may then access the search results at a later time, share the search results with other users, and/or perform other operations, by, for example, returning to the saved history. In one example, the user may click a “save name” button included in the display. The results of the naming conflict search, including, for example, one or more potential naming conflicts, are then noted as a name of interest and/or saved. A user may, for example, click the “save name” button to note that a name searched merits further consideration. A user might, for example, save a name because the graphical representation of the naming conflicts indicates a low likelihood of conflict between the name and potential naming conflicts. In another example, an interface is provided to reject a name. To reject a name, a user may, for example, click a “reject name” button included in the display. A user might, for example, reject a name because the graphical representation of the naming conflicts indicates a high likelihood of conflict between the name and potential naming conflicts.

In a further example, an interface is provided to highlight and/or otherwise mark particular naming conflict(s) that are graphically represented in the display. To highlight and/or otherwise mark a naming conflict, a user may, for example, click on a marker 620 associated with the naming conflict and select a “highlight naming conflict” and/or other menu option. In another example, an interface is provided to remove marker(s) 620 and associated potential naming conflicts from the display. To remove a naming conflict, a user may, for example, click on a marker 620 and select a “remove naming conflict” and/or other menu option.

FIG. 6B is a diagram illustrating embodiments of a graphical display. The graphical display 600 shown in FIG. 6B is similar to the graphical display 600 of FIG. 6A. The graphical display 600 illustrates a user's interaction with the markers in the display 600. In various embodiments, a user clicks, hovers over, and/or otherwise interacts with a marker 624 in the graphical display 600, and in response to the indication of interaction with the marker, information 660 associated with the potential naming conflict is displayed. The information associated with a potential naming conflict may include, for example, a goods and services description of the potential naming conflict, trademark classes associated with the conflict, information associated with the owner of the potential naming conflict, and/or any other type of information. In some embodiments, the information associated with a potential naming conflict may include a link to a document such as a portable document format (PDF) document, a link to a webpage, and/or a link to any other source including information associated with the potential naming conflict. In certain cases, clicking on a marker may generate a PDF or other document including information related to the naming conflict.

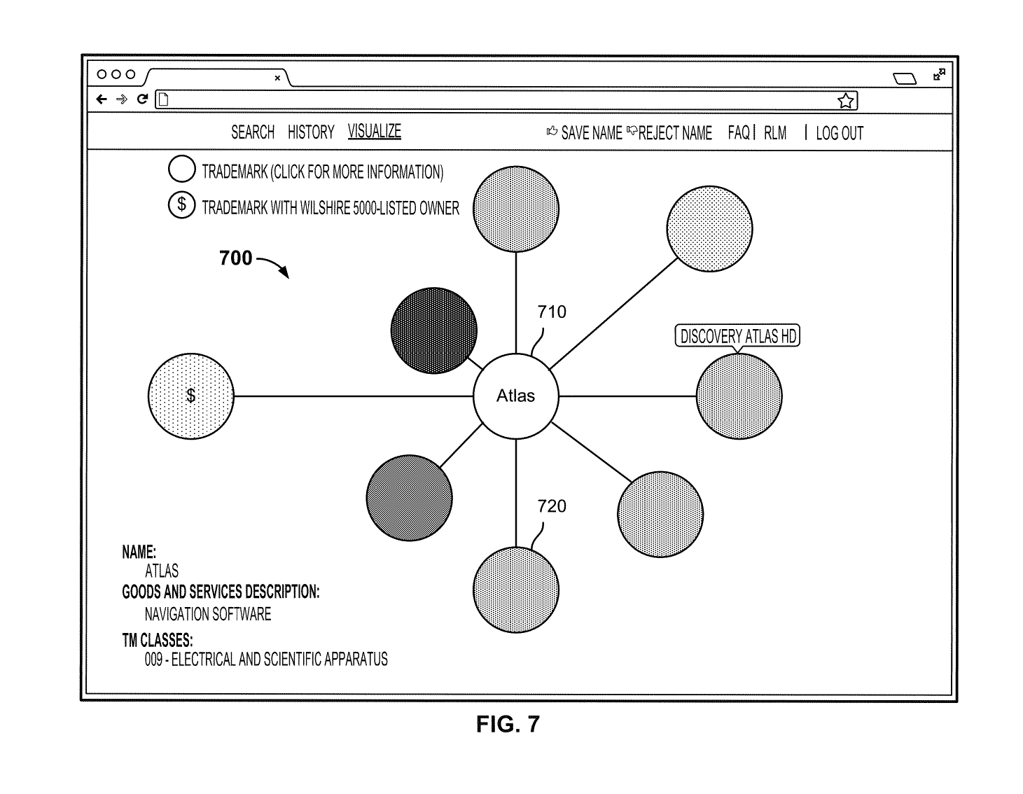

FIG. 7 is a diagram illustrating embodiments of a graphical display. In various embodiments, the cluster diagram display 700 illustrated in FIG. 7 includes similar elements to the oval-shaped display 600 illustrated in FIGS. 6A and 6B. In the example shown, a cluster diagram display 700 includes a locus 710 representing a name “ATLAS” that is graphically displayed at a center of the display 700. Markers 720 representing potential naming conflicts are displayed at various distances from the locus 710. The coordinate locations of markers 720, a visualization attribute representing potential naming conflicts, are determined based on a relevance score-based distance for the potential naming conflict. In various embodiments, visualization attributes such as color are determined for each marker 720 based on a relevance score associated with that marker and/or naming conflict. In the example shown, the shadings of the markers 720 represent various colors. Markers associated with higher relevance scores may be displayed in red or another color indicating a higher threat level, and markers associated with lower relevance scores may be displayed in a cool color, such as white, that indicates lower threat level.

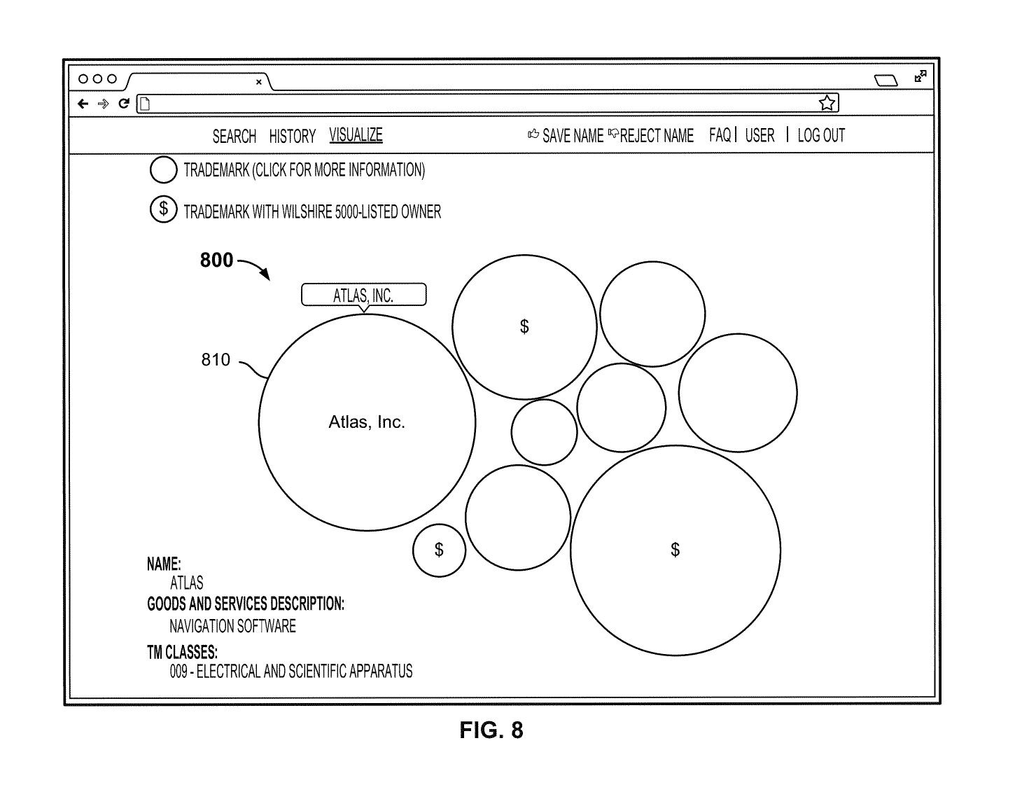

FIG. 8 is a diagram illustrating embodiments of a graphical display. The example bubble chart display 800 may be provided as a result of a naming conflict search for the term “Atlas,” goods and services description “navigation software,” and trademark class “009—Electrical and Scientific Apparatus.” In the example shown, a bubble chart display 800 includes markers 810 (bubbles) representing potential naming conflicts. The size of each bubble 810 in the display is determined based on a relevance score-based size value for the marker. For example, the larger bubbles represent naming conflicts associated with higher relevance scores and smaller bubbles represent naming conflicts associated with lower relevance scores. In certain cases, a marker representing the name “Atlas” is not displayed. In display 800, the size of a marker 810 representing a naming conflict represents the relevance of that naming conflict. In this display 800, larger markers represent naming conflicts with higher relevance scores and smaller markers represent naming conflicts with lower relevance scores.

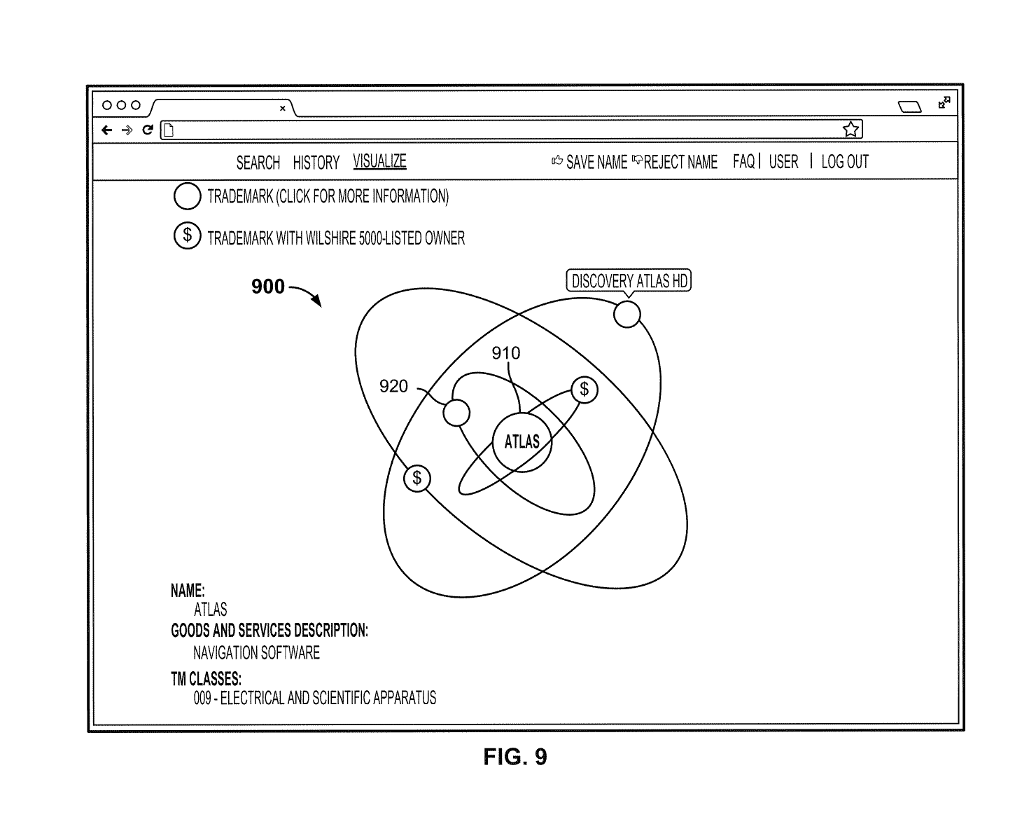

FIG. 9 is a diagram illustrating embodiments of a three-dimensional graphical display. In the example shown, a three-dimensional display 900 includes a locus 910 representing a name “ATLAS” that is graphically displayed at a center of the display 900. Markers 920 representing potential naming conflicts are displayed at various distances from the locus 910. The three-dimensional display 900 resembles an atom including electrons orbiting a nucleus and/or another type of three-dimensional display. In this display, the closer a marker 920 is to the center locus 910, the higher the relevance score associated with the marker 920.

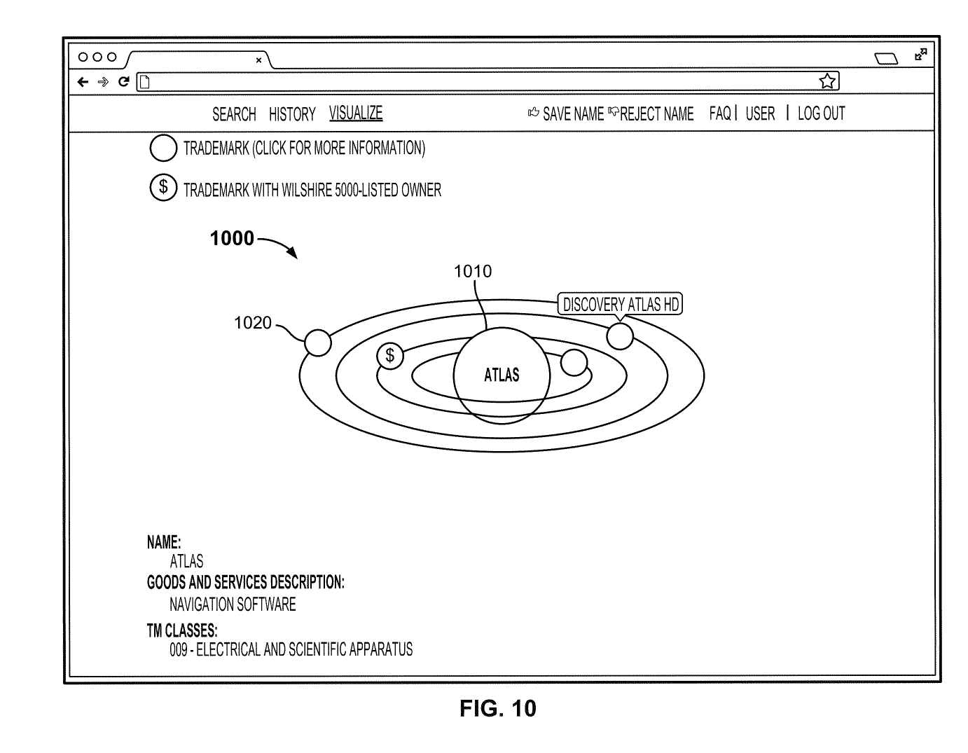

FIG. 10 is a diagram illustrating embodiments of a three-dimensional graphical display. In the example shown, a three-dimensional display 1000 includes a locus 1010 representing a name “ATLAS” that is graphically displayed at a center of the display 1000. Markers 1020 representing potential naming conflicts are displayed at various distances from the locus 1010. The three-dimensional display 1000 resembles a planetary system including potential naming conflict markers 1020 orbiting a locus 1010 including a marker representing a name. In this display, the closer a marker 1020 is to the center locus 1010, the higher the relevance score associated with the marker 1020.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of visualizing a plurality of potential naming conflicts, comprising:
analyzing similarities of the plurality of naming conflicts;
translating the similarities into distances from a given locus; and
graphically representing each of the naming conflicts within an area that includes the locus, wherein the naming conflicts are represented by markers at the distances from the locus.

2. The method of claim 1, further comprising:
receiving a name; and
querying one or more databases based at least in part on the name to retrieve the naming conflicts and information associated with each naming conflict.

3. The method of claim 1, wherein the potential naming conflicts include a trademark.

4. The method of claim 1, wherein the potential naming conflicts include a brand.

5. The method of claim 1, wherein the potential naming conflicts include a company name.

6. The method of claim 1, wherein analyzing the similarities further comprises:
generating, for each of the naming conflicts, a feature vector representing factors associated with the naming conflict; and
determining, for each of the naming conflicts, a relevance score based at least in part on the feature vector associated with the naming conflict.

7. The method of claim 6, wherein determining the relevance score includes:
applying a transformation to the feature vector to determine the relevance score.

8. The method of claim 6, wherein determining the relevance score comprises:
applying weights to each of the factors included in the feature vector; and
generating the relevance score for each of the naming conflicts based at least in part on the application of the weights to the factors.

9. The method of claim 8, wherein the weights are adjustable by a user.

10. The method of claim 8, wherein the weights are determined at least in part using a machine learning operation.

11. The method of claim 1, wherein translating the similarities into distances comprises:
processing, for each of the naming conflicts, a relevance score to determine a distance; and
determining, for each of the naming conflicts, a coordinate based at least in part on the distance.

12. The method of claim 1, wherein graphically representing each of the naming conflicts within an area includes:
determining, for each of the naming conflicts, a coordinate relative to the locus, the coordinate being based at least in part on a determined distance from the locus;
graphically representing the locus; and
graphically representing, for each of the naming conflicts, a marker representing the naming conflict at the determined coordinate.

13. The method of claim 1, wherein at least a subset of the markers includes a link to information associated with a naming conflict.

14. The method of claim 1, further comprising:
receiving a hover indication corresponding to a marker; and
providing, in response to the hover indication, information related to a naming conflict corresponding to the marker.

15. The method of claim 1, further comprising:
receiving a click indication corresponding to a marker; and
providing, in response to the click indication, a document including information related to a naming conflict corresponding to the marker.

16. The method of claim 1, wherein a marker representing a naming conflict includes an indicator representing a source of the naming conflict.

17. The method of claim 1, wherein graphically representing each of the naming conflicts within the area includes graphically representing the naming conflicts in a display resembling an oval-shaped target.

18. The method of claim 1, wherein graphically representing each of the naming conflicts within the area includes graphically representing the naming conflicts in a cluster diagram.

19. The method of claim 1, wherein graphically representing each of the naming conflicts within the area includes graphically representing the naming conflicts in a three-dimensional display.

20. A system for visualizing a plurality of potential naming conflicts, comprising:
a processor; and
a memory coupled with the processor, wherein the memory is configured to provide the processor with instructions which when executed cause the processor to:
analyze similarities of the plurality of naming conflicts;
translate the similarities into distances from a given locus; and
graphically represent each of the naming conflicts within an area that includes the locus, wherein the naming conflicts are represented by markers at the distances from the locus.

21. A computer program product to visualize a plurality of potential naming conflicts, the computer program product being embodied in a tangible computer readable storage medium and comprising computer instructions for:
analyzing similarities of the plurality of naming conflicts;
translating the similarities into distances from a given locus; and
graphically representing each of the naming conflicts within an area that includes the locus, wherein the naming conflicts are represented by markers at the distances from the locus.
